(19) United States
(12) Patent Application Publication
(10) Pub. No.: US 2024/0100943 A1
(43) Pub. Date: Mar. 28, 2024

(54) TOOL-LESS NEUTRAL RELEASE MECHANISM FOR OUTDOOR POWER EQUIPMENT

(71) Applicant: MTD PRODUCTS INC, Valley City, OH (US)

(72) Inventor: Timothy Clapp, Queen Creek, AZ (US)

(21) Appl. No.: 18/239,349

(22) Filed: Aug. 29, 2023

Related U.S. Application Data
(60) Provisional application No. 63/409,920, filed on Sep. 26, 2022.

(51) Int. Cl. B60K 23/08

(52) U.S. Cl. CPC B60K 23/08; B60K 2023/0883

(57) ABSTRACT

A neutral release mechanism for an outdoor power equipment is discussed. One example embodiment comprises a neutral release mechanism that switches a gearbox or a transmission between neutral mode and drive, comprising: a user input that rotates between a first angle and a second angle; and a plunger coupled to the user input and a pin, wherein the plunger and the pin move parallel to an axis of the drive wheel between a first and a second position, wherein the pin is at the first position when the user input is at the first angle and the second position when the user input is at the second position, wherein the pin places the gearbox or the transmission in drive when the pin is at the first position and places the gearbox or the transmission in neutral when the pin is at the second position.

### CROSS-REFERENCE TO RELATED APPLICATIONS

This application claims the benefit of U.S. Provisional Application No. 63/409,920 filed Sep. 26, 2022, which is hereby incorporated by reference within the presented disclosure in its entirety and for all purposes.

### FIELD OF DISCLOSURE

The disclosed subject matter pertains to apparatuses and methods for placing gearboxes coupled to drive motors in neutral in outdoor power equipment, for example, apparatuses and methods for placing drive motors in neutral without the need for tools.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

For many outdoor power equipment (e.g., ride-on mowers, etc.), the equipment can be relatively easy to move when propelled by its own motor(s) but can be quite difficult to move if the motor remains engaged with the drive wheels but is inactive (e.g., turned off, battery out of power, etc.). Accordingly, some outdoor power equipment comprise means to place the gearboxes or transmissions in neutral so that the equipment can be easier to move when not propelled by its own motor(s).

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure include a neutral release mechanism for an outdoor power equipment. A first example embodiment is a neutral release mechanism configured to switch one of a gearbox or a transmission of a drive wheel between a neutral mode and a drive mode, comprising: a user input configured to be rotated between a first angular position and a second angular position; and a plunger coupled to the user input and to a neutral release pin, wherein the plunger and the neutral release pin are configured to move parallel to an axis of the drive wheel between a first axial position of the neutral release pin and a second axial position of the neutral release pin, wherein the neutral release pin is configured to be at the first axial position when the user input is at the first angular position and at the second axial position when the user input is at the second axial position, wherein the neutral release pin is configured to place the one of the gearbox or the transmission in the drive mode when the neutral release pin is at the first axial position, and wherein the neutral release pin is configured to place the one of the gearbox or the transmission in the neutral mode when the neutral release pin is at the second axial position. When moved to the second axial position, the neutral release pin pushes on another component inside the gearbox which couples the drive motor to the gearbox, allowing the drive motor to be uncoupled from the gearbox when the neutral release pin is at the second axial position.

According to another aspect, an embodiment can include an outdoor power equipment, comprising: a frame; one or more drive wheels coupled to the frame; a prime mover configured to drive rotation of at least one of an associated gearbox or an associated transmission for each drive wheel of the one or more drive wheels; and a first neutral release mechanism coupled to a first drive wheel of the one or more drive wheels, comprising: a user input configured to be rotated between a first angular position and a second angular position; and a plunger coupled to the user input and to a neutral release pin, wherein the plunger and the neutral release pin are configured to move parallel to an axis of rotation of the first drive wheel between a first axial position of the neutral release pin and a second axial position of the neutral release pin, wherein the neutral release pin is configured to be at the first axial position when the user input is at the first angular position and at the second axial position when the user input is at the second axial position, wherein, when the neutral release pin is at the first axial position, the first drive wheel is coupled to and configured to rotate with the associated gearbox or the associated transmission of the first drive wheel, and wherein, when the neutral release pin is at the second axial position, the neutral release pin is configured to decouple the first drive wheel from the one of the associated gearbox or the associated transmission of the first drive wheel, such that the first drive wheel is configured to rotate independently of the one of the associated gearbox or the associated transmission of the first drive wheel.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 illustrates a front view of a drive wheel comprising a first example tool-less neutral release according to various embodiments discussed herein.

FIG. 2 illustrates an additional front perspective view of the first example neutral release, according to various embodiments discussed herein.

FIG. 3 illustrates a rear perspective view of a drive wheel comprising the first example tool-less neutral release according to various embodiments discussed herein.

FIG. 4 illustrates a rear perspective view of the first example neutral release without the drive wheel or gearbox components, according to various embodiments discussed herein.

FIG. 4A illustrates a gearbox endplate comprising features to align with a release mechanism housing and user input of neutral release, according to various embodiments discussed herein.

FIG. 5 illustrates a front view and a side cross-sectional view of the first example neutral release in an engaged position, according to various embodiments discussed herein.

FIG. 5A illustrates a front view and a side cross-sectional view of the first example neutral release in a disengaged position, according to various embodiments discussed herein.

FIG. 6 illustrates a rear view of a user input and neutral release pin of the first example neutral release, showing an input helix of the user input, according to various embodiments discussed herein.

FIG. 7 illustrates a side perspective view and front view of a plunger of the first example neutral release, according to various embodiments discussed herein.

FIG. 8 illustrates an exploded view of the neutral release and gearbox housing, according to various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to neutral release systems for power equipment machines are described herein, it should be understood that the disclosed machines, devices and methods are not so limited and modifications may be made without departing from the scope of the present disclosure. The scope of the systems, methods, and devices are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

Various embodiments can comprise a tool-less neutral release mechanism that allows a drive motor to be disengaged from a drive wheel by an operator of an outdoor power equipment by hand, without the need for any tools. Although various embodiments are discussed in the specific context of a lawn maintenance apparatus (e.g., ride-on mower), embodiments discussed herein can be employed in connection with any of a variety of outdoor power equipment.

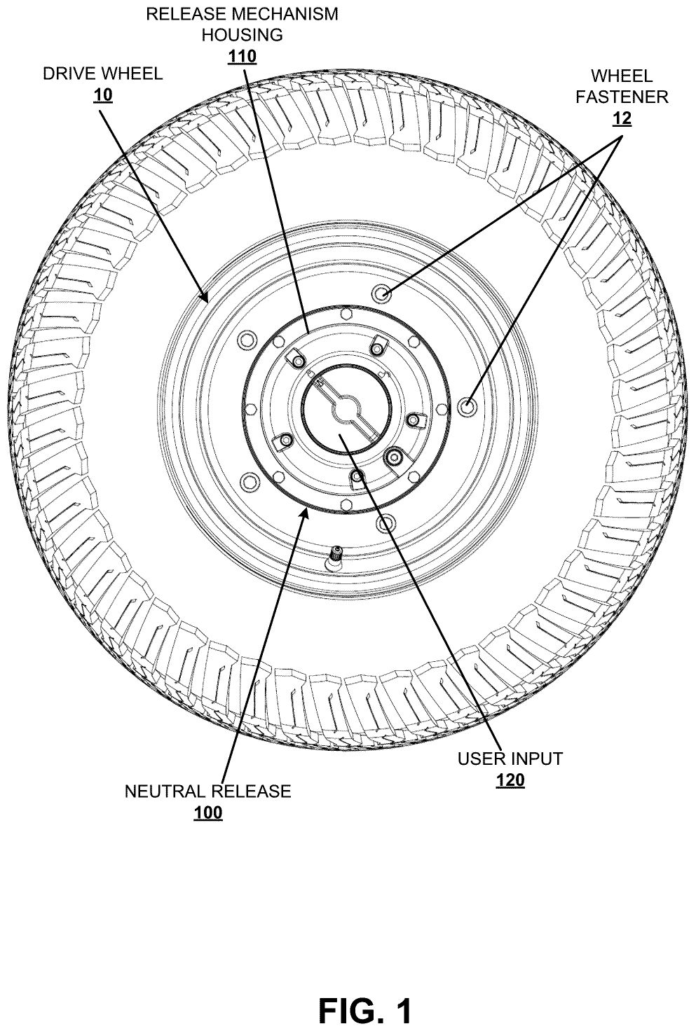

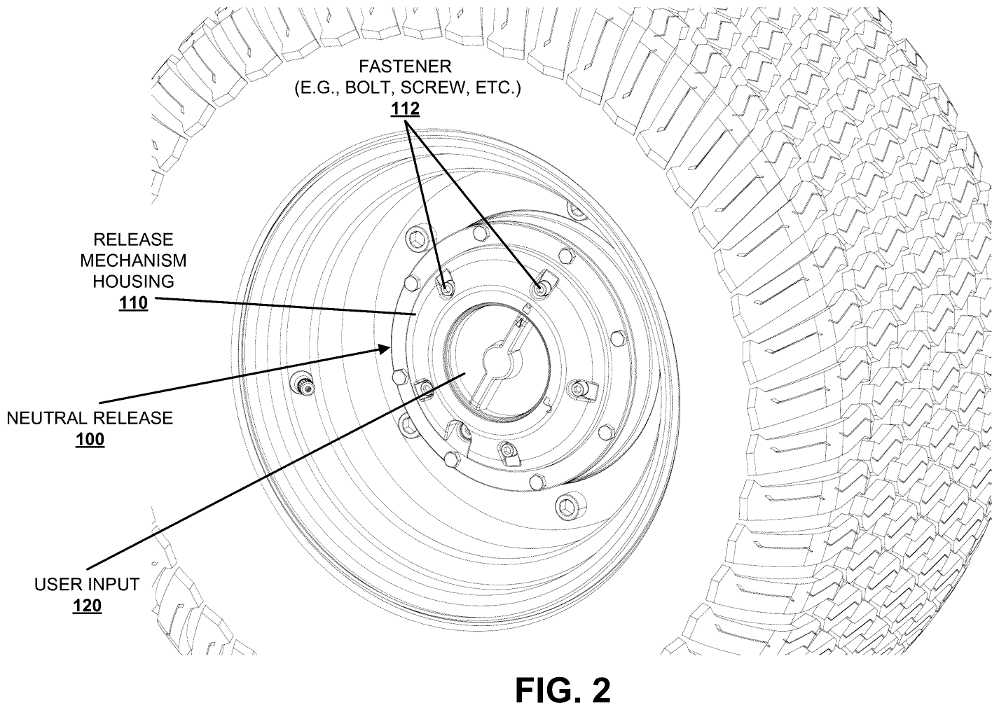

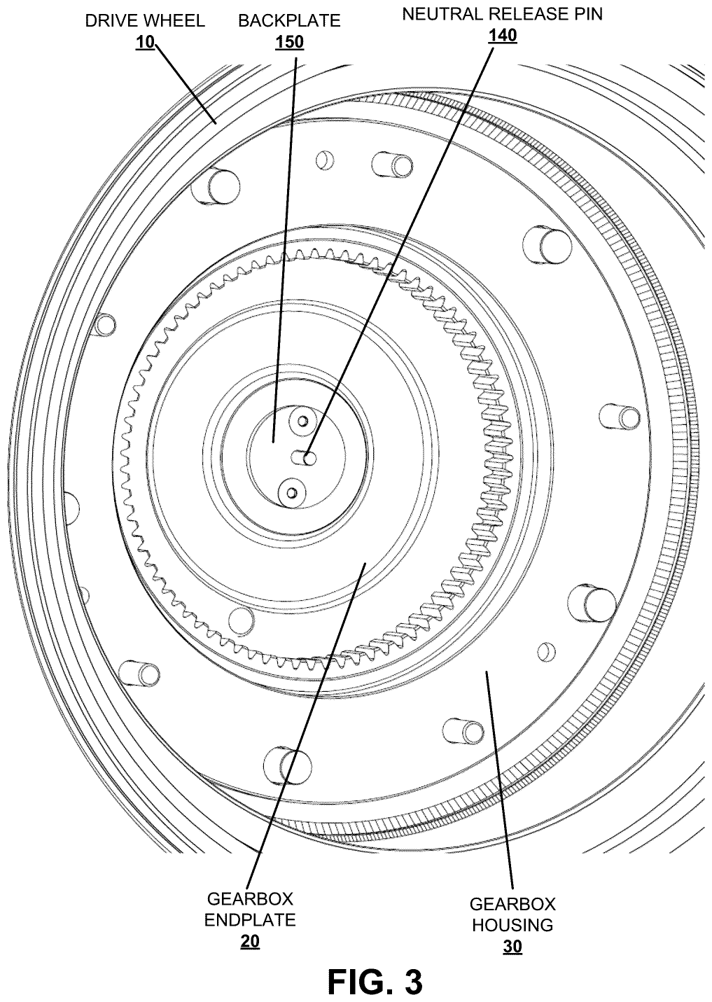

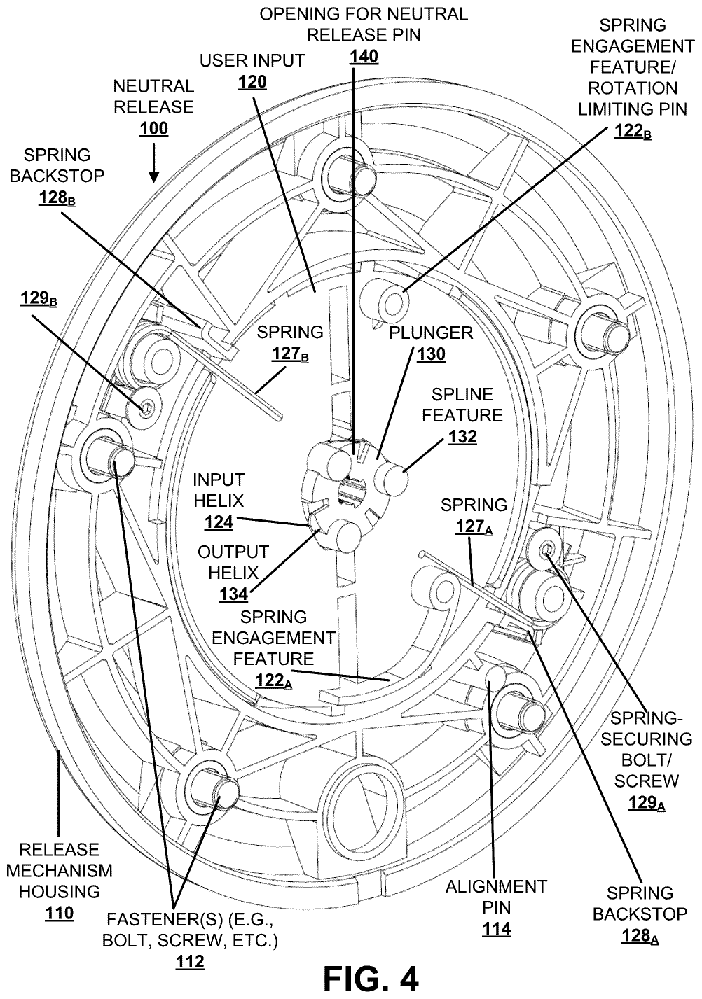

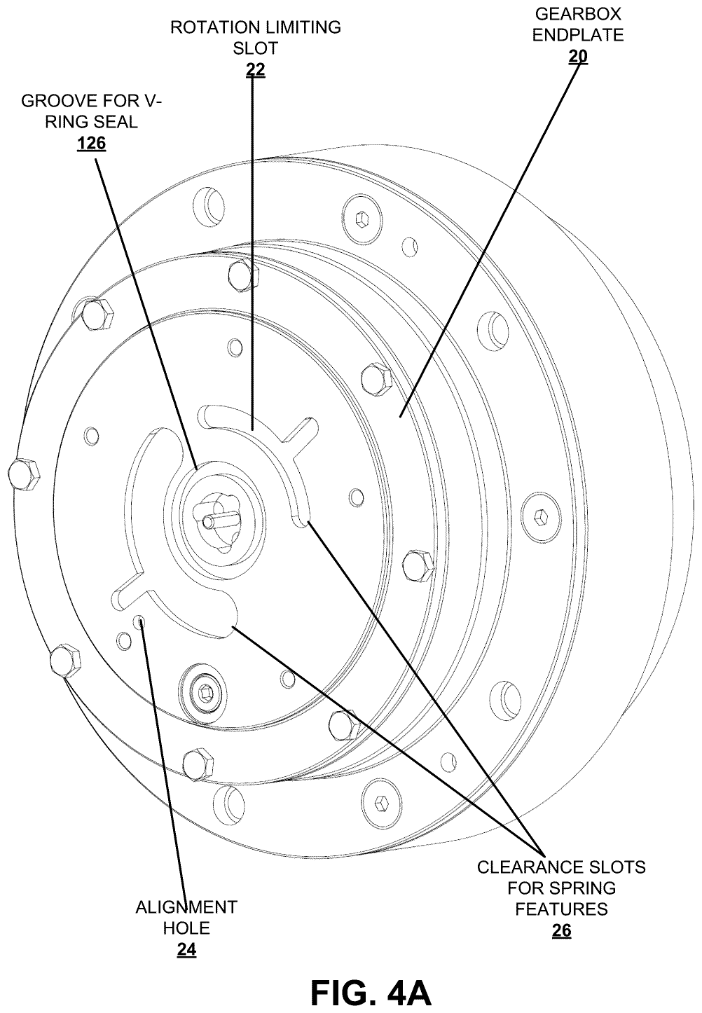

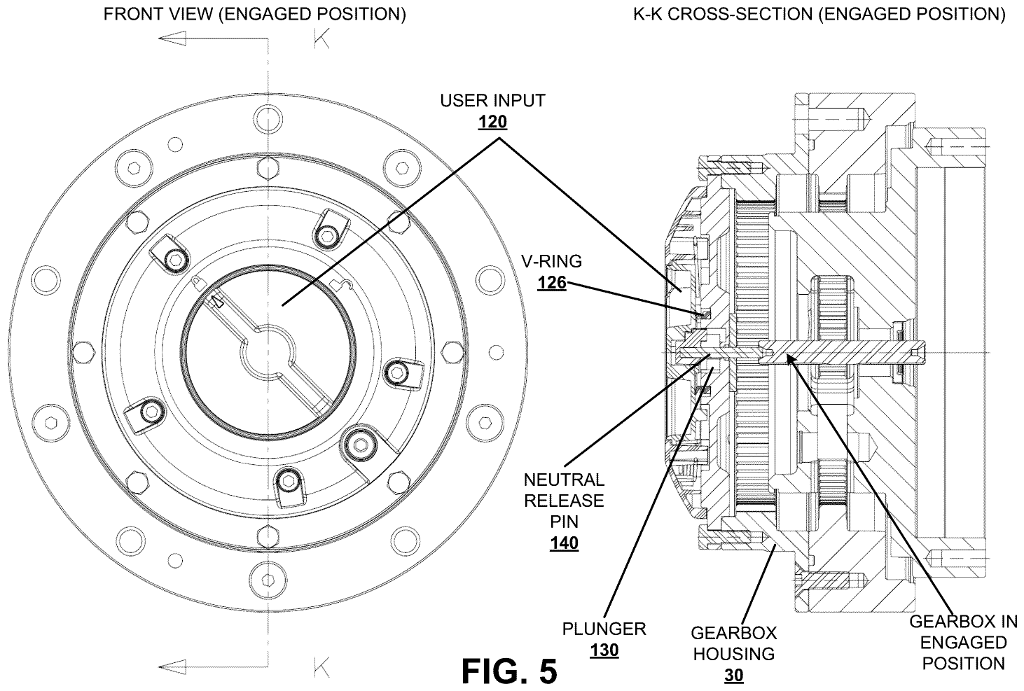

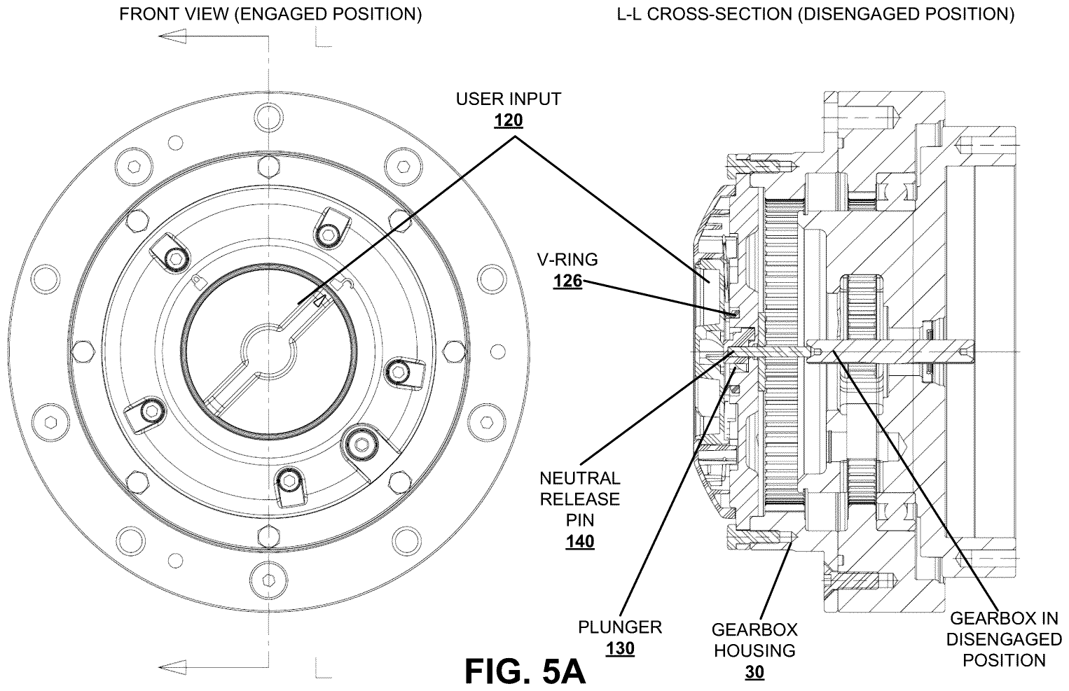

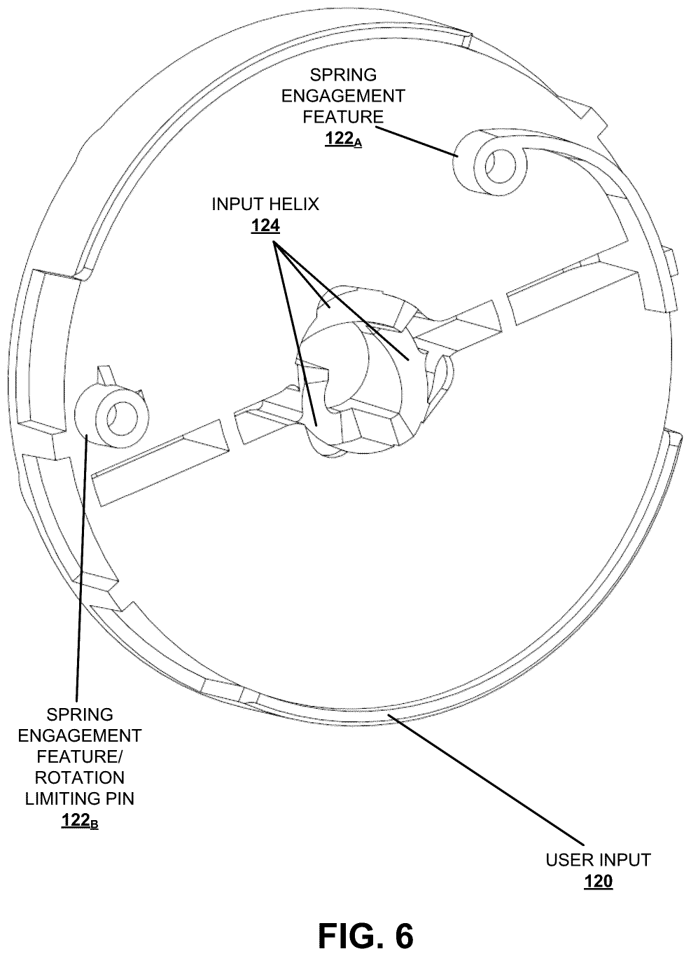

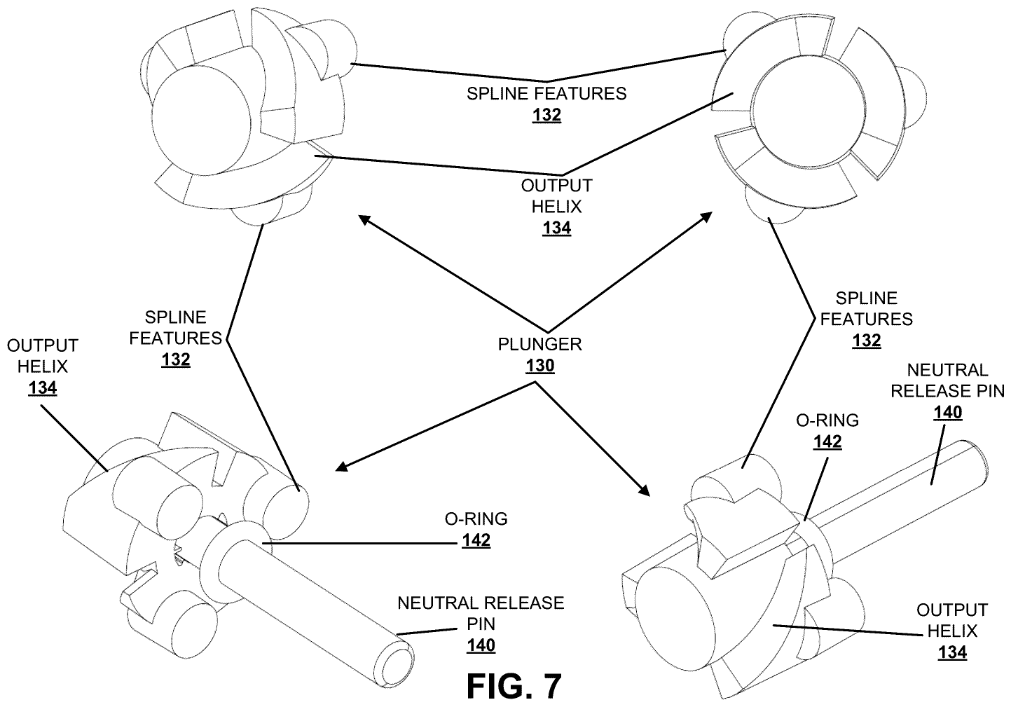

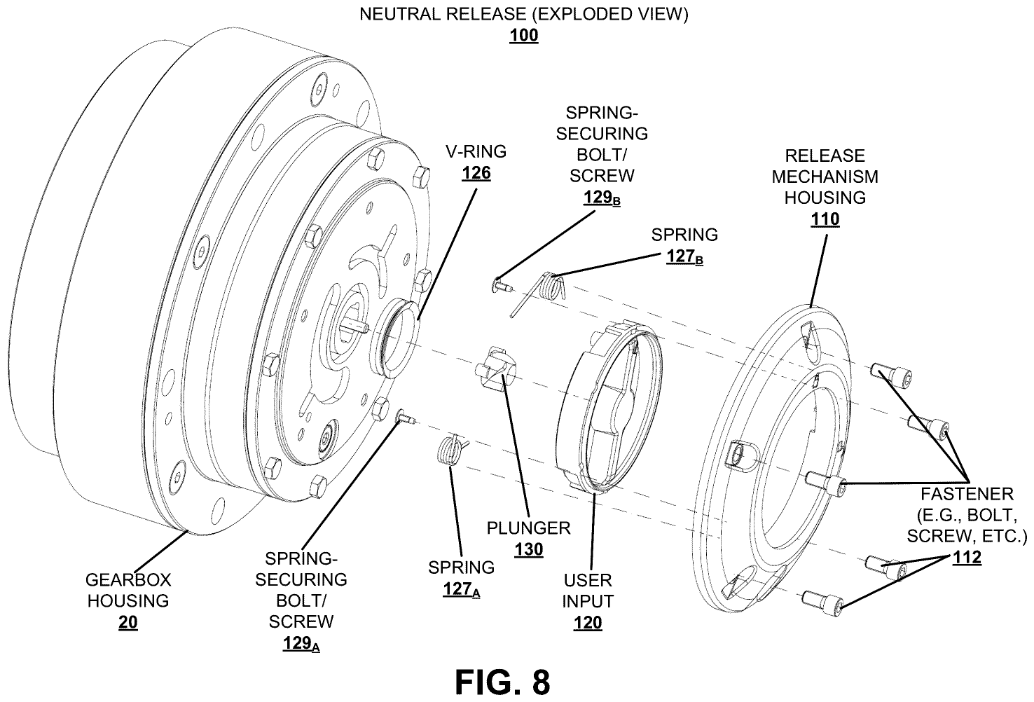

A first example embodiment of a tool-less neutral release mechanism is discussed in connection with FIGS. 1-8. Referring to FIG. 1, illustrated is a front view of a drive wheel 10 comprising a tool-less neutral release 100 according to various embodiments discussed herein. Referring to FIG. 2, illustrated is a front perspective view of neutral release 100, according to various embodiments discussed herein. Referring to FIG. 3, illustrated is a rear perspective view of a drive wheel 10 comprising a tool-less neutral release 100 according to various embodiments discussed herein. FIG. 4 illustrates a rear perspective view of neutral release 100 without drive wheel 10 or gearbox components, according to various embodiments discussed herein. Referring to FIG. 4A, illustrated is a gearbox endplate comprising features to align with a release mechanism housing and user input of neutral release 100, according to various embodiments discussed herein. Referring to FIG. 5, illustrated are a front view and side cross-sectional view along line K-K of the front view of neutral release 100 in an engaged position, according to various embodiments discussed herein. Referring to FIG. 5A, illustrated are a front view and side cross-sectional view along line L-L of the front view of neutral release 100 in a disengaged position, according to various embodiments discussed herein. Referring to FIG. 6, illustrated is a rear view of user input 120 of a neutral release 100, showing an input helix 124 and spring engagement features 122_{A} and 122_{B} of user input 120, according to various embodiments discussed herein. Referring to FIG. 7, illustrated are a side perspective view and front view of a plunger of a neutral release 100, according to various embodiments discussed herein. Referring to FIG. 8, illustrated is an exploded view of the neutral release 100 and gearbox housing 20, according to various aspects discussed herein. As used herein, a front view is a view facing drive wheel 10 and/or neutral release 100 from outside a power equipment on which drive wheel 10 has been mounted, and a rear view is a view facing the side of drive wheel 10 and/or neutral release 100 that would be closest to the center of the power equipment when mounted on an outdoor power equipment.

The neutral release 100 can comprise multiple components, the operation of which is discussed in greater detail below. Those components can include a release mechanism housing 110, user input 120, plunger 130, and a neutral release pin 140, and can also include one or more other components, such as one or more fasteners 112, O-rings and/or V-rings (e.g., V-ring 126, O-ring 142, etc.), one or more return springs 127 (e.g., 127_{A}, 127_{B}, etc.) which can engage with one or more spring engagement features 122 (e.g., 122_{A}, 122_{B}, etc.) to bias neutral release in 140 toward an engaged angular position and away from a neutral angular position unless secured into the neutral angular position. In various embodiments, each of user input 120, plunger 130, and neutral release pin 140 can be coaxial with one another. In some embodiments, such as the example embodiments shown in the Figures, user input 120, plunger 130, and neutral release pin 140 can be coaxial with one another and with drive wheel 10 and the drive motor. Additionally, in various embodiments, neutral release 100 can be a self-contained modular apparatus that can be installed, removed, or replaced without requiring removal of other components of drive wheel 10 or the drive motor.

Release mechanism housing 110 can act as a cover for internal components of neutral release 100 and a user input (e.g., handle, etc.) 120 that can be actuated by a user to place an associated drive motor (not shown) in neutral or engage it with drive wheel 10, which can be secured to gearbox housing 30 via fasteners 12. Release mechanism housing 110 can be secured to a gearbox housing 30 by any of a variety of means, such as one or more fasteners 112 (e.g., screws, bolts, etc.). An alignment pin 114 on release mechanism housing 110 can engage with alignment hole 24 of gearbox endplate 20 to rotationally align release mechanism housing 110 with gearbox endplate 20.

User input 120 can be located between release mechanism housing 110 and gearbox housing 20 and secured in position by fastener(s) 112, etc. to prevent axial motion (movement inward or outward along the axis of rotation of drive wheel 10, etc.) of user input 120. The front (e.g., outer face) of user input 120 can comprise a handle, knob, etc. that can receive user input in the form of rotating user input 120, for example, between a first angular position (e.g., corresponding to the drive motor being in drive) and a second angular position (e.g., corresponding to the drive motor being in neutral). In various embodiments, the first angular position and the second angular position can be approximately 90° apart (e.g., 85°-95°, 80°-100°, 70°-110°, 60°-120°, etc.). The rear of user input 120 can comprise an input helix 124 that can be coupled with an output helix 134 of a plunger 130 of neutral release 100, and a rotation limiting pin 122_{B} that can align with a rotation limiting slot of gearbox endplate 20 to permit rotation of user input 120 between the first and second angular positions.

Optionally, user input 120 can comprise (e.g., integrally, or secured via one or more connectors, etc.) one or more spring engagement features 122 (e.g., 122_{A} and 122_{B}, etc.) that can engage with one or more (e.g., one, two, three or more, etc.) springs 127 (e.g., torsional springs such as 127_{A} and 127_{B}, respectively, or any of a variety of other types of springs, etc.) of neutral release 100 such that rotation of user input 120 away from the engaged/drive angular position causes a spring force in springs 127 biasing user input 120 back to the engaged/drive angular position unless secured into the neutral angular position. In various embodiments, one or more of the spring engagement feature(s) 122 (e.g., 122_{B}, etc.) can also service as a rotation limiting pin to prevent user input 120 being rotated to angles other than those of the engaged angular position, the angular neutral position, and angles between the engaged angular position and the neutral angular position (in other embodiments, a separate rotation limiting pin can be employed).

In various embodiments, each spring 127 can be coupled with an associated spring engagement feature 122. In some embodiments, each spring engagement feature 122 can be coupled with a single spring 127, while in other embodiments at least one spring engagement feature 122 can be coupled with two or more springs 127 for each of the at least one spring engagement feature(s) 122.

In some such embodiments comprising two or more springs 127 and two or more associated spring engagement features 122, each combination of spring 127 and associated spring engagement feature 122 can bias the user input 120 toward the engaged/drive angular position through an associated angular range, wherein each associated angular range is distinct from each other associated angular range (e.g., not identical, but potentially overlapping or non-overlapping, etc.). As one example embodiment, spring 127_{A} and spring engagement feature 122_{A} can have a first angular range from approximately 0 degrees (as a relative angular displacement from the engaged/drive angular position toward a neutral angular position of 2×, e.g., for 2×=90 degrees, etc.) to approximately x degrees and spring 127_{B} and spring engagement feature 122_{B} can have a second angular range from approximately x degrees to approximately 2× degrees (e.g., wherein the first and second angular ranges can partially overlap, etc.).

In embodiments comprising spring(s) 127, neutral release 100 can comprise spring-securing bolt(s)/screw(s) 129 (e.g., one for each spring 127, such as 129_{A} for spring 127_{A} and 129_{B} for spring 127_{B}, etc.) to maintain springs 127 in position within release mechanism housing 110. Neutral release 100 can also comprise spring backstop(s) 128 (e.g., one for each spring 127, such as 128_{A} for spring 127_{A} and 128_{B} for spring 127_{B}, etc.) or similar features (e.g., depending on the type of spring(s) 127, etc.) that can also maintain spring(s) 127 in position and/or bias spring(s) 127 away from their neutral position(s) to provide continuous and/or greater resistive force to bias user input. In some embodiments, such as those shown in FIG. 4, spring backstop(s) 128 can be integral portions of release mechanism housing 110, while in other embodiments they can be separate components.

Plunger 130 can comprise the output helix 134, as well as one or more spline features 132 to align plunger 130 angularly with gearbox housing 20, which can comprise one or more complementary spline feature(s) 22 that align with spline feature(s) 132. The alignment between spline feature(s) 22 and spline feature(s) 132 can restrict rotation of plunger 130 relative to drive wheel 20 and can also provide track(s) along which plunger 130 can move axially relative to user input 120 and gear cover 20. Additionally, input helix 124 can align with output helix 134, to allow a user to control the axial position of plunger 130 via rotation of user input 120. Plunger 130 can also be coupled to (or in some embodiments comprise) a neutral release pin 140, which can move axially (either toward or away from user input 120, etc.) with plunger 130.

Neutral release pin 140 can couple with at least a portion of a gearbox or transmission that can couple to a drive motor configured to rotate drive wheel 10, such that a threshold axial displacement of neutral release pin 140 away from user input 120 can place the drive motor in neutral and returning neutral release pin 140 to within the threshold axial displacement from user input 120 can place the gearbox or transmission in gear. In various embodiments, a return spring can be coupled to neutral release pin 140 to bias it toward user input 120, such that neutral release pin 140 can return to an outer position in the absence of being held inward by plunger 130.

In various embodiments, neutral release mechanism 100 can comprise one or more rings or seals (e.g., O-ring(s), V-ring(s), etc. to keep dust and other contaminants out of neutral release 100 and/or the drive motor at one or more positions, such as between neutral release housing 110 and gearbox housing 20 (e.g., V-ring 126, etc.), between housing 110 and user input 120, and/or between neutral release pin 140 and the drive motor (e.g., O-ring 142, etc.).

In operation, a user wishing to place a drive motor in neutral can rotate an associated user input 120 through a threshold angle from a first position (e.g., associated with the drive motor being engaged with the drive wheel 10) to a second position (e.g., associated with the drive motor being in neutral). As user input 120 rotates from a drive position to a neutral position, plunger 130, which is coupled with user input 120 via input helix 124 of user input 120 and output helix 134 of plunger 130, can move axially away from user input 120. Thus, rotation of user input 120 (which is axially constrained but rotationally free) can translate into axial motion of plunger 130 (which is rotationally constrained but axially free). Axial motion of plunger 130 away from user input 120 can also move neutral release pin 140, which is coupled to plunger 130. Moving neutral release pin 140 can disengage the drive motor from the gearbox or transmission, placing it into neutral.

A user wishing to place a drive motor in drive from neutral can rotate an associated user input 120 through a threshold angle from a second position (e.g., associated with the drive motor being in neutral) to a first position (e.g., associated with the drive motor being engaged). As user input 120 rotates from the second position to a first position, plunger 130, which is coupled with user input 120 via input helix 124 of user input 120 and output helix 134 of plunger 130 and biased toward user input 120 by a return spring, can move axially toward user input 120, moving neutral release pin 140 away from drive motor, thereby re-engaging the gearbox or transmission.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

The following examples pertain to further embodiments.

Example 1 is a neutral release mechanism configured to switch one of a gearbox or a transmission of a drive wheel between a neutral mode and a drive mode, comprising: a user input configured to be rotated between a first angular position and a second angular position; and a plunger coupled to the user input and to a neutral release pin, wherein the plunger and the neutral release pin are configured to move parallel to an axis of the drive wheel between a first axial position of the neutral release pin and a second axial position of the neutral release pin, wherein the neutral release pin is configured to be at the first axial position when the user input is at the first angular position and at the second axial position when the user input is at the second axial position, wherein the neutral release pin is configured to place the one of the gearbox or the transmission in the drive mode when the neutral release pin is at the first axial position, and wherein the neutral release pin is configured to place the one of the gearbox or the transmission in the neutral mode when the neutral release pin is at the second axial position.

Example 2 comprises the subject matter of any variation of example(s) 1, further comprising a release mechanism housing configured to secure the neutral release mechanism to a gearbox housing of the drive wheel, wherein the release mechanism housing and the gearbox housing are configured to restrict axial movement of the user input.

Example 3 comprises the subject matter of any variation of example(s) 2, further comprising a plurality of fasteners configured to secure the release mechanism housing to the gearbox housing.

Example 4 comprises the subject matter of any variation of example(s) 2-3, wherein the plunger comprises one or more spline features configured to align with one or more complementary spline features of the gearbox housing, wherein the one or more spline features and the one or more complementary spline features are configured to restrict rotational movement of the plunger.

Example 5 comprises the subject matter of any variation of example(s) 1-4, wherein the first angular position is separated from the second angular position by approximately 90°.

Example 6 comprises the subject matter of any variation of example(s) 1-5, wherein the user input comprises an input helix, wherein the plunger comprises an output helix, and wherein the user input is coupled to the plunger via the input helix being coupled to the output helix.

Example 7 comprises the subject matter of any variation of example(s) 1-6, wherein each of the user input, the plunger, and the neutral release pin is coaxial with the drive wheel.

Example 8 comprises the subject matter of any variation of example(s) 1-7, wherein the user input comprises a rotation limiting pin configured to align with a rotation limiting slot that limit rotation of the user input to between the first angular position and the second angular position.

Example 9 comprises the subject matter of any variation of example(s) 1-8, further comprising one or more springs configured to couple with one or more spring engagement features of the user input to bias the user input toward the first angular position when the user input is between the first angular position and the second angular position.

Example 10 comprises the subject matter of any variation of example(s) 9, wherein the one or more springs comprise: a first spring configured to couple with the one or more spring engagement features of the user input to bias the user input toward the first angular position when the user input is between the first angular position and a third angular position approximately halfway between the first and second angular positions; and a second spring configured to couple with the one or more spring engagement features of the user input to bias the user input toward the first angular position when the user input is between the second angular position and a fourth angular position approximately halfway between the first and second angular positions, wherein the third angular position is one of the fourth angular position or closer to the second angular position than the fourth angular position.

Example 11 comprises the subject matter of any variation of example(s) 9, wherein a first spring engagement feature of the one or more spring engagement features is configured to align with a rotation limiting slot that limit rotation of the user input to between the first angular position and the second angular position.

Example 12 is a outdoor power equipment, comprising: a frame; one or more drive wheels coupled to the frame; a prime mover configured to drive rotation of at least one of an associated gearbox or an associated transmission for each drive wheel of the one or more drive wheels; and a first neutral release mechanism coupled to a first drive wheel of the one or more drive wheels, comprising: a user input configured to be rotated between a first angular position and a second angular position; and a plunger coupled to the user input and to a neutral release pin, wherein the plunger and the neutral release pin are configured to move parallel to an axis of rotation of the first drive wheel between a first axial position of the neutral release pin and a second axial position of the neutral release pin, wherein the neutral release pin is configured to be at the first axial position when the user input is at the first angular position and at the second axial position when the user input is at the second axial position, wherein, when the neutral release pin is at the first axial position, the first drive wheel is coupled to and configured to rotate with the associated gearbox or the associated transmission of the first drive wheel, and wherein, when the neutral release pin is at the second axial position, the neutral release pin is configured to decouple the first drive wheel from the one of the associated gearbox or the associated transmission of the first drive wheel, such that the first drive wheel is configured to rotate independently of the one of the associated gearbox or the associated transmission of the first drive wheel.

Example 13 comprises the subject matter of any variation of example(s) 12, wherein the first neutral release mechanism further comprises a release mechanism housing configured to secure the neutral release mechanism to an associated gearbox housing of the first drive wheel, wherein the release mechanism housing and the associated gearbox housing of the first drive wheel are configured to restrict axial movement of the user input.

Example 14 comprises the subject matter of any variation of example(s) 13, wherein the first neutral release mechanism further comprises a plurality of fasteners configured to secure the release mechanism housing to the gearbox housing.

Example 15 comprises the subject matter of any variation of example(s) 13-14, wherein the plunger comprises one or more spline features configured to align with one or more complementary spline features of the associated gearbox housing of the first drive wheel, wherein the one or more spline features and the one or more complementary spline features are configured to restrict rotational movement of the plunger.

Example 16 comprises the subject matter of any variation of example(s) 12-15, wherein the first angular position is separated from the second angular position by approximately 90°.

Example 17 comprises the subject matter of any variation of example(s) 12-16, wherein the user input comprises an input helix, wherein the plunger comprises an output helix, and wherein the user input is coupled to the plunger via the input helix being coupled to the output helix.

Example 18 comprises the subject matter of any variation of example(s) 12-17, wherein each of the user input, the plunger, and the neutral release pin is coaxial with the axis of rotation of the first drive wheel.

Example 19 comprises the subject matter of any variation of example(s) 12-18, wherein the user input comprises a rotation limiting pin configured to align with a rotation limiting slot that limit rotation of the user input to between the first angular position and the second angular position.

Example 20 comprises the subject matter of any variation of example(s) 12-19, wherein the first neutral release mechanism further comprises one or more springs configured to couple with one or more spring engagement features of the user input to bias the user input toward the first angular position when the user input is between the first angular position and the second angular position.

Example 21 comprises the subject matter of any variation of example(s) 20, wherein the one or more springs comprise: a first spring configured to couple with the one or more spring engagement features of the user input to bias the user input toward the first angular position when the user input is between the first angular position and a third angular position approximately halfway between the first and second angular positions; and a second spring configured to couple with the one or more spring engagement features of the user input to bias the user input toward the first angular position when the user input is between the second angular position and a fourth angular position approximately halfway between the first and second angular positions, wherein the third angular position is one of the fourth angular position or between the second angular position and the fourth angular position.

Example 22 comprises the subject matter of any variation of example(s) 20-21, wherein a first spring engagement feature of the one or more spring engagement features is configured to align with a rotation limiting slot that limit rotation of the user input to between the first angular position and the second angular position.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A neutral release mechanism configured to switch one of a gearbox or a transmission of a drive wheel between a neutral mode and a drive mode, comprising:
a user input configured to be rotated between a first angular position and a second angular position; and
a plunger coupled to the user input and to a neutral release pin, wherein the plunger and the neutral release pin are configured to move parallel to an axis of the drive wheel between a first axial position of the neutral release pin and a second axial position of the neutral release pin,
wherein the neutral release pin is configured to be at the first axial position when the user input is at the first angular position and at the second axial position when the user input is at the second axial position,
wherein the neutral release pin is configured to place the one of the gearbox or the transmission in the drive mode when the neutral release pin is at the first axial position, and
wherein the neutral release pin is configured to place the one of the gearbox or the transmission in the neutral mode when the neutral release pin is at the second axial position.

2. The neutral release mechanism of claim 1, further comprising a release mechanism housing configured to secure the neutral release mechanism to a gearbox housing of the drive wheel, wherein the release mechanism housing and the gearbox housing are configured to restrict axial movement of the user input.

3. The neutral release mechanism of claim 2, further comprising a plurality of fasteners configured to secure the release mechanism housing to the gearbox housing.

4. The neutral release mechanism of claim 2, wherein the plunger comprises one or more spline features configured to align with one or more complementary spline features of the gearbox housing, wherein the one or more spline features and the one or more complementary spline features are configured to restrict rotational movement of the plunger.

5. The neutral release mechanism of claim 1, wherein the first angular position is separated from the second angular position by approximately 90°.

6. The neutral release mechanism of claim 1, wherein the user input comprises an input helix, wherein the plunger comprises an output helix, and wherein the user input is coupled to the plunger via the input helix being coupled to the output helix.

7. The neutral release mechanism of claim 1, wherein each of the user input, the plunger, and the neutral release pin is coaxial with the drive wheel.

8. The neutral release mechanism of claim 1, wherein the user input comprises a rotation limiting pin configured to align with a rotation limiting slot that limit rotation of the user input to between the first angular position and the second angular position.

9. The neutral release mechanism of claim 1, further comprising one or more springs configured to couple with one or more spring engagement features of the user input to bias the user input toward the first angular position when the user input is between the first angular position and the second angular position.

10. The neutral release mechanism of claim 9, wherein the one or more springs comprise:
a first spring configured to couple with the one or more spring engagement features of the user input to bias the user input toward the first angular position when the user input is between the first angular position and a third angular position approximately halfway between the first and second angular positions; and
a second spring configured to couple with the one or more spring engagement features of the user input to bias the user input toward the first angular position when the user input is between the second angular position and a fourth angular position approximately halfway between the first and second angular positions,
wherein the third angular position is one of the fourth angular position or closer to the second angular position than the fourth angular position.

11. The neutral release mechanism of claim 9, wherein a first spring engagement feature of the one or more spring engagement features is configured to align with a rotation limiting slot that limit rotation of the user input to between the first angular position and the second angular position.

12. An outdoor power equipment, comprising:
a frame;
one or more drive wheels coupled to the frame;
a prime mover configured to drive rotation of at least one of an associated gearbox or an associated transmission for each drive wheel of the one or more drive wheels; and
a first neutral release mechanism coupled to a first drive wheel of the one or more drive wheels, comprising:
a user input configured to be rotated between a first angular position and a second angular position; and
a plunger coupled to the user input and to a neutral release pin, wherein the plunger and the neutral release pin are configured to move parallel to an axis of rotation of the first drive wheel between a first axial position of the neutral release pin and a second axial position of the neutral release pin,
wherein the neutral release pin is configured to be at the first axial position when the user input is at the first angular position and at the second axial position when the user input is at the second axial position,
wherein, when the neutral release pin is at the first axial position, the first drive wheel is coupled to and configured to rotate with the associated gearbox or the associated transmission of the first drive wheel, and
wherein, when the neutral release pin is at the second axial position, the neutral release pin is configured to decouple the first drive wheel from the one of the associated gearbox or the associated transmission of the first drive wheel, such that the first drive wheel is configured to rotate independently of the one of the associated gearbox or the associated transmission of the first drive wheel.

13. The outdoor power equipment of claim 12, wherein the first neutral release mechanism further comprises a release mechanism housing configured to secure the neutral release mechanism to an associated gearbox housing of the first drive wheel, wherein the release mechanism housing and the associated gearbox housing of the first drive wheel are configured to restrict axial movement of the user input.

14. The outdoor power equipment of claim 13, wherein the first neutral release mechanism further comprises a plurality of fasteners configured to secure the release mechanism housing to the gearbox housing.

15. The outdoor power equipment of claim 13, wherein the plunger comprises one or more spline features configured to align with one or more complementary spline features of the associated gearbox housing of the first drive wheel, wherein the one or more spline features and the one or more complementary spline features are configured to restrict rotational movement of the plunger.

16. The outdoor power equipment of claim 12, wherein the first angular position is separated from the second angular position by approximately 90°.

17. The outdoor power equipment of claim 12, wherein the user input comprises an input helix, wherein the plunger comprises an output helix, and wherein the user input is coupled to the plunger via the input helix being coupled to the output helix.

18. The outdoor power equipment of claim 12, wherein each of the user input, the plunger, and the neutral release pin is coaxial with the axis of rotation of the first drive wheel.

19. The outdoor power equipment of claim 12, wherein the user input comprises a rotation limiting pin configured to align with a rotation limiting slot that limit rotation of the user input to between the first angular position and the second angular position.

20. The outdoor power equipment of claim 12, wherein the first neutral release mechanism further comprises one or more springs configured to couple with one or more spring engagement features of the user input to bias the user input toward the first angular position when the user input is between the first angular position and the second angular position.

21. The outdoor power equipment of claim 20, wherein the one or more springs comprise:
a first spring configured to couple with the one or more spring engagement features of the user input to bias the user input toward the first angular position when the user input is between the first angular position and a third angular position approximately halfway between the first and second angular positions; and
a second spring configured to couple with the one or more spring engagement features of the user input to bias the user input toward the first angular position when the user input is between the second angular position and a fourth angular position approximately halfway between the first and second angular positions,
wherein the third angular position is one of the fourth angular position or between the second angular position and the fourth angular position.

22. The outdoor power equipment of claim 20, wherein a first spring engagement feature of the one or more spring engagement features is configured to align with a rotation limiting slot that limit rotation of the user input to between the first angular position and the second angular position.
